(19) United States
(12) Patent Application Publication
(10) Pub. No.: US 2021/0146716 A1
(43) Pub. Date: May 20, 2021

(54) METHOD OF MARKING A SOLID-STATE MATERIAL, MARKINGS FORMED FROM SUCH METHODS AND SOLID-STATE MATERIALS MARKED ACCORDING TO SUCH A METHOD

(71) Applicant: Master Dynamic Limited, Pak Shek Kok, New Territories (HK)

(72) Inventors: Siu Lung LUI, Pak Shek Kok, New Territories (HK); Yingnan WANG, Pak Shek Kok, New Territories (HK); Jianxing HUANG, Pak Shek Kok, New Territories (HK)

(21) Appl. No.: 16/622,606

(22) PCT Filed: Feb. 22, 2019
(86) PCT No.: PCT/CN2019/075953

§ 371 Date: Dec. 13, 2019

(30) Foreign Application Priority Data
Feb. 23, 2018 (HK) 18102632.0

(51) Int. Cl. B44C 1/22; B44B 3/00; B41M 5/26; A44C 17/00; B28D 5/00

(52) U.S. Cl. CPC B44C 1/228; B44B 3/009; B28D 5/00; A44C 17/00; B41M 5/262

(57) ABSTRACT

A method of forming a non-optically detectable identifiable marking invisible to the naked eye is formed from plural recesses of multiple levels at an outer surface of an article formed from a solid-state material. The method includes forming plural recesses of multiple levels within a predetermined region of a photoresist applied to an outer surface of an article formed from a solid-state material. The plural recesses are formed by grayscale lithography and the recesses extend at least partially through the photoresist and towards the outer surface of the article formed from a solid-state material. The method also includes applying an etching process such that at least a portion of the outer surface of said article is exposed and etched to form plural etched portions extending into the article from its outer surface and corresponding to plural recesses; wherein said predetermined region of said photoresist defines an identifiable marking to be applied to the outer surface of said article; wherein said plurality of etched portions forms the non-optically identifiable marking on the outer surface of said article.

### TECHNICAL FIELD

The present invention relates to the field of marking of solid state materials, and more particularly to the marking of gemstones including diamonds.

### BACKGROUND OF THE INVENTION

Gemstone identification and grading has been long-established by international standards laboratories including GIA, IGI, Gem-A and NGTC. The identification and grading result is typically stored in an electronic media such as hard-disks, tapes, compact discs and the like, and a paper certificate is issued along with the corresponding gemstone.

When the certificate is lost, or when the gemstone is mixed with other gemstones, the identity of the gemstone is lost, and is required to be recertified.

The direct marking of gemstones including diamonds is a generally straight-forward method to avoid such circumstance and allows for re-identification.

Conventional techniques within the art for the marking of gemstones including diamonds include laser marking and ion beam marking.

However, when using laser marking, generates coarse patterns and leaves unrecoverable ablation marks on the gemstone, causing permanent damage and can devalue the gemstone.

When using ion beam marking, such a technique can be used to inscribe fine patterns on the surface of the gemstone which can be 1000 times smaller than those using laser marking, however the process is typically relatively slow and requires precision.

Other than item identification, gemstone marking can provide traceability of an item such that its origin, its owner, and its features and the like. Such marking techniques can also assist in the prevention of the counterfeiting of precious articles such as artworks or jewellery, and be of assistance in the incident of theft.

### OBJECT OF THE INVENTION

It is an object of the present invention to provide a process for the marking of solid state materials, including gemstones and an identification marking which overcomes or at least partly ameliorates at least some deficiencies as associated with the prior art.

### SUMMARY OF THE INVENTION

In a first aspect, the present invention provides a method of forming a non-optically detectable identifiable marking invisible to the naked eye, said marking is formed from a plurality of recesses of multiple levels at an outer surface of an article formed from a solid-state material, and said method including the steps of:
(i) forming a plurality of recesses of multiple levels within a predetermined region of a photoresist applied to an outer surface of an article formed from a solid-state material, wherein said plurality of recesses of multiple levels is formed by grayscale lithography and wherein said one or more recesses extend at least partially through the photoresist and towards said outer surface of the article formed from a solid-state material; and
(ii) applying an etching process such that at least a portion of the outer surface of said article is exposed and etched so as to form a plurality of etched portions extending into said article from the outer surface of the article and corresponding to said plurality of recesses;
wherein said predetermined region of said photoresist defines an identifiable marking to be applied to the outer surface of said article; wherein said plurality of etched portions forms the non-optically identifiable marking on the outer surface of said article.

The marking may be viewable by use of a 10× loupe or a 20× loupe. Alternatively, the maximum width of the etched portions of the article less than 200 nm such that the identifiable marking is non-optically detectable in the visible light spectrum.

The plurality of recesses may extend through the photoresist and so as to provide one or more apertures therethrough and providing one or more exposed portions of said outer surface of the article prior to application of the etching process, such that etched portions corresponding to the one or more apertures have depths into the article of approximately the same depth.

The recesses may extend through the photoresist at varying depths to each other prior to application of the etching process, such that the etched portions have varying depths into the article.

The grayscale lithography process may use masks with holes of different sizes and shapes.

The grayscale lithography pattern is preferably generated by laser interference lithography.

The grayscale lithography pattern may be generated by direct laser writing in the photoresist.

The recesses of said plurality of recesses maybe arrange in a periodic and uniform arrangement with respect to each other within said predetermined region of a photoresist. Alternatively, the recesses of said plurality of recesses are arranged in a non-periodic and non-uniform arrangement with respect to each other within said predetermined region of a photoresist.

The photoresist may have a uniform thickness, or may have a non-uniform thickness.

The outer surface of said article may be a flat surface, or may be a non-flat surface.

The recesses of said plurality of recesses may be of the same width, or said plurality of recesses may have non-uniform widths.

One or more recesses may be formed from a plurality of adjacent recesses.

Preferably, the etching process is a plasma etching process.

One or more recesses of the plurality of recesses may be inclined with respect to the outer surface of an article.

One or more recesses of the plurality of recesses may be curved in at least one plane with respect to the outer surface of an article.

The solid state material is preferably selected from the group of gemstones consisting of diamond, pearl, silicon, and synthetic sapphire.

In a second aspect, the present invention provides an article formed from solid state material having a non-optically detectable identifiable marking thereon which is invisible to the naked eye, wherein said non-optically detectable identifiable marking is applied to said solid state material by the method according to the first aspect.

The solid state material is preferably selected from the group of gemstones including diamond, pearl, silicon, and synthetic sapphire.

The marking may be viewable and inspected by use of a 10× loupe or a 20× loupe. Alternatively, the marking may be non-optically detectable under the visible light spectrum.

### BRIEF DESCRIPTION OF THE DRAWINGS

In order that a more precise understanding of the above-recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

The accompany drawings illustrate the present invention and explain its principle. In the drawings, like reference numbers refer to like parts throughout:

FIG. 1 shows the characteristic of the photoresist suitable for the purpose of grayscale lithography;

FIG. 2 shows a graph illustrating the response of the photoresist upon different excitation conditions;

FIG. 3 shows a photoresist mask for the creation of 2.5D pattern in grayscale lithography;

FIG. 4 shows how laser interference can be applied to grayscale lithography;

FIG. 5 shows the application of grayscale lithography on non-flat surface; and

FIG. 6 shows the complete process of creating the marking on the article.

### DETAILED DESCRIPTION OF THE DRAWINGS

In order that a more precise understanding of the above-recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

The present invention is directed to a method to provide a non-optically detectable identification marking at an outer surface of an article formed from a solid-state material. Although the description and examples as follows is directed to the marking of gemstones, in particular diamonds, the present invention is applicable to the marking of the surface of any solid-state material.

The process of a marking on a surface of an article of solid state material in accordance with the present invention consists of two process steps:
(i) forming a mask of photoresist on the surface of an article, and
(ii) subsequently etching the surface of the article.

The mask is comprised of a plurality of recesses formed within a predefined region of a photoresist which is applied to an outer surface of the article.

The plurality of recesses is formed by grayscale lithography, and one or more recesses extend at least partially through the photoresist from an outer surface of the photoresist and towards said outer surface of the article formed from a solid-state material upon which the mask is applied.

The etching process is plasma etching, which can be microwave plasma etching, reactive-ion etching (RIE), or inductively-coupled plasma (ICP) etching.

The etching process removes at least a portion of the outer surface of said article to form a plurality of etched portions extending into the article from the outer surface of the article and corresponding to said plurality of recesses which are formed in the photoresist.

Advantageously, the present inventors have utilized properties of grayscale lithography to provide the photoresist provided at the outer surface of the article from a solid-state material to be of uneven thickness at a predefined area. As such, the patterns to be created are in multi-level, or, two and a half-dimensional (2.5D).

The etching process then removes the material at the surface of the article at a constant rate, regardless of whether the material is photoresist or the substrate.

This results in a plurality of etched portions at the predetermined region of said photoresist, forming the non-optically detectable identification marking on the outer surface of the article.

In embodiments of the invention, the maximum width of the etched portions of the article can be less than 200 nm, so that the marking is non-optically detectable under the visible light spectrum, and does not change the appearance of the article or result in a marking which is unsightly. Such marking being non-optically detectable is termed an “invisible marking”.

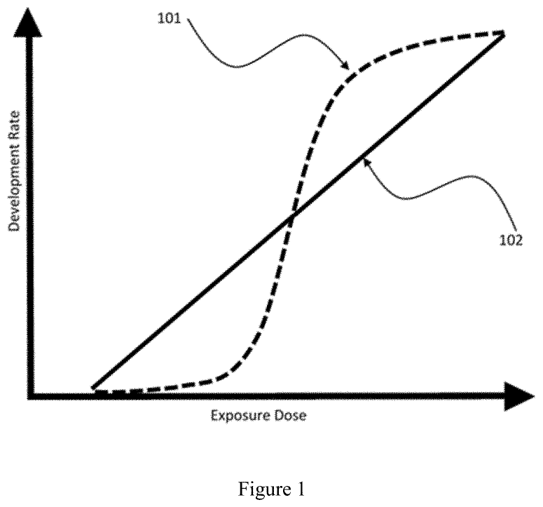

Referring to FIG. 1, there is shown a schematic representation of the method of the present invention of forming a non-optically detectable identification marking at an outer surface of an article formed from a solid-state material 10.

In grayscale lithography, the selection of a photoresist is critical and paramount. In conventional photolithography, an ideal photoresist is required to have a distinct response upon exposure. The photoresist is chemically changed when exposed to radiation such as UV or visible light, regardless the intensity of the illumination. This type of response is required to fabricate patterns with high dimensional accuracy and with high contrast.

Referring to FIG. 1, in practice, a common photoresist has a response curve 101 as shown. The photoresist does not react until a certain threshold is met. Development rate is then proportional to the exposure dose and becomes saturated. With such response behavior, one typically has to over-dose in order to create a reliable pattern.

However, such high exposure may damage the substrate or article to which the marking is to be applied, and the patterns created is typically limited to two-dimensional patterns.

The photoresist used in grayscale lithography may have several features. Firstly, instead of having a sharp response curve which is favored in convention lithography, the photoresist is preferred to have a wide exposure dose window so the development rate can be controlled by the exposure dose. Such response behavior is illustrated by the response curve 102 of FIG. 1 wherein the solid response curve 102 shows that the development rate of the photoresist is proportional to the exposure dose.

Another characteristic of the photoresist used in grayscale lithography is that the photoresist may change its absorptivity or transmissivity upon exposure. In one example to illustrate this property, a photoresist AZ 9260 is semi-transparent to UV and the typical penetration depth for UV exposure is 1 to 2 microns.

Under a UV exposure dose, the absorptivity of the photoresist changes such that said photoresist becomes transparent. Another term to describe this behavior is “photo-bleached”. When the top layer of said photoresist is bleached, the UV exposure can reach deeper into the photoresist to continue the reaction.

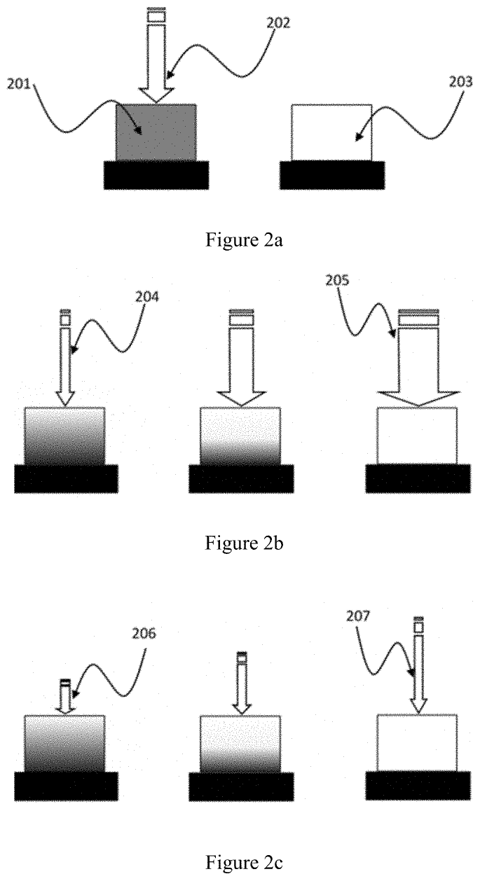

The development of common photoresists and photoresist for grayscale development is illustrated in FIGS. 2a, 2b and 2c. In FIG. 2a, a common photoresist 201 is depicted to be exposed by an excitation 202. When the dose is above the development threshold, the photoresist 203 reacts.

By contrast, in grayscale intensity, the development rate is controlled by the exposure dose E, which can be expressed as:

E=|t,

where | is the exposure flux and t is the exposure time.

This concept is demonstrated and depicted in FIGS. 2b and 2c, in which the two parameters are adjusted.

Referring to FIG. 2b, the narrow arrow 204 denotes weak exposure flux and the wide arrow 205 indicates the strong exposure flux. As is depicted, under strong exposure, the photoresist can be completely bleached.

Referring to FIG. 2c, the length of arrows scales with the exposure time t. While maintaining a constant exposure flux, a shorter exposure time 206 will only expose the surface layer of the photoresist, whereas when the exposure time is long enough as represented by arrow 207, the photoresist can be completely bleached.

For an excitation source that has a large illumination area, or non-adjustable intensity and timing, the pattern cannot be generated by directly exposing the photoresist to the excitation source. As such, grayscale mask is needed to control the exposure dose to the photoresist.

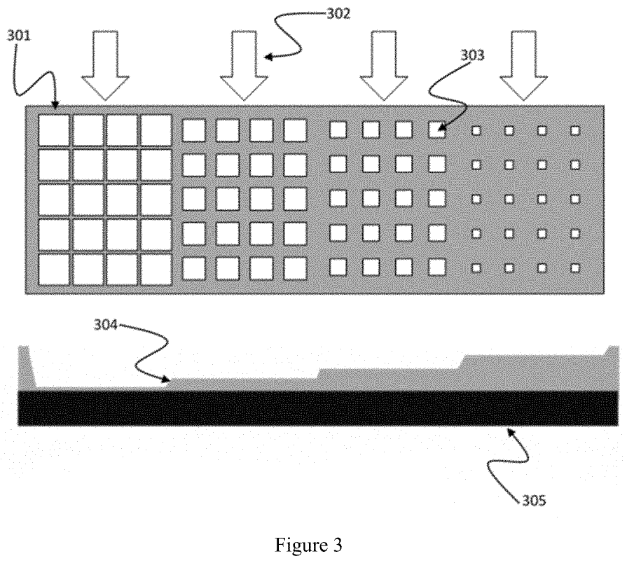

A method to implement this control is shown in an embodiment in which the dose is adjusted by the size of the holes across the photoresist mask which is placed in between the illumination and the substrate coated with photoresist as represented and depicted in FIG. 3.

As shown in FIG. 3 an example of a mask is shown, whereby four sets of square hole matrices 303 are imprinted on a photoresist mask 301. These holes 303 are of different sizes so the amount of light passing through the mask 301 to the photoresist 304 can be controlled by the openings 303.

Referred back to the exposure dose expression, this grayscale mask approach varies the exposure flux I to the photoresist upon being exposed by excitation 302, so that development rate is different at different portions of the photoresist 304 on the substrate 305. The final pattern is a step-wise structure as shown.

One short-coming of this mask-approach to create a 2.5D pattern is that the resolution of the final pattern is limited by the fabrication method and quality of the mask.

Even if a technology can create a mask of high resolution, the diffraction of excitation at the tiny hole has to be taken into consideration because this destroys the resolution.

Therefore, a more practical approach for grayscale lithography is to use an excitation source in which the intensity and the timing of said excitation source can be adjusted.

A light amplification by stimulated emission of radiation device, generally known as laser, is a common solution to this application.

Nowadays, the intensity of a laser radiation can be easily adjusted for any lasing devices, and the size of the laser spot can be focused down to the micron scale with appropriate set of lenses.

Then the flux I can be tuned with a correct set of parameters. For the exposure time t, ultrafast lasers can generate laser pulse in femtosecond time scale. By controlling the number of laser pulse to be fired, the exposure time t can be fine-tuned in a time scale of femtosecond. This implies an ultra-high resolution of the exposure dose to the photoresist.

In grayscale lithography, exposure of photoresist by direct laser writing is a common approach, however the exposure of the photoresist can be done by other optical techniques.

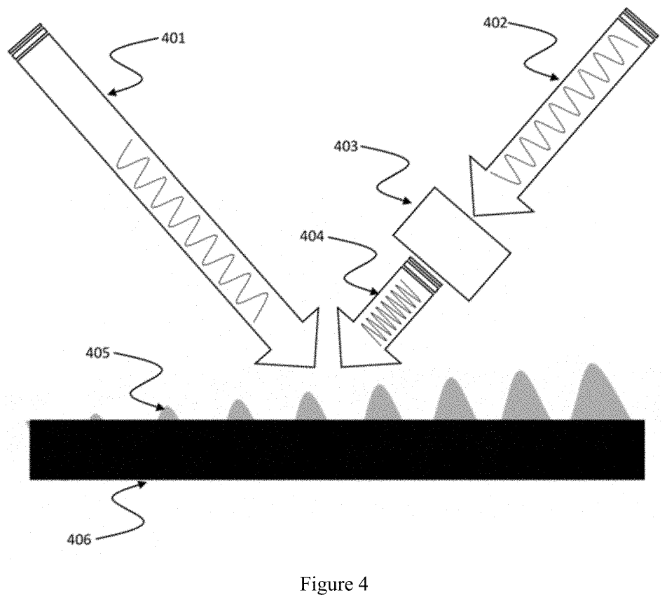

Laser interference lithography is another approach to expose photoresist for grayscale lithography, and this principle is illustrated in FIG. 4. A beam of a coherent light source, such as a laser, is split into two by means of beam splitting elements such as a grating, a polarizer, a beam splitter or the like.

These two split beams are directed to different paths for modulations. The reference beam 401 is irradiated directly to photoresist 405, while the other beam 402 is directed to a set of optical modulation components 403 and emitted as beam 404 wherein the phase and/or the intensity are changed.

The beam 401 and beam 404 recombine and interfere. The resultant beam has an uneven intensity distribution across the surface of the photoresist 405 on the substrate 406. This variation of exposure flux I induced different exposure doses to the photoresist 405 and creates 2.5D pattern on the photoresist 405 after development.

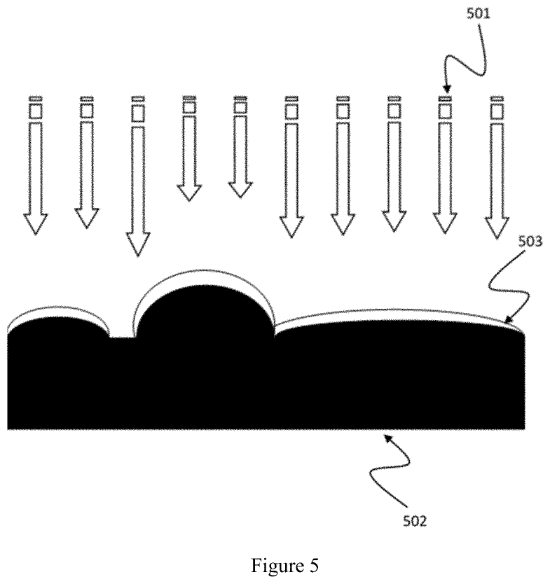

Another feature of grayscale lithography is that the pattern of the photoresist can be generated on a substrate with non-flat or uneven surface as depicted in FIG. 5.

In conventional lithography, the thickness of the photoresist layer being coated on the substrate is typically uncontrollable for a non-flat or uneven substrate surface. As conventional lithography cannot precisely control the depth of the exposure and the development rate, an accurate pattern cannot be written precisely on the photoresist in technique of the prior art.

The use of grayscale lithography provides a solution of developing photoresist on a non-flat substrate surface. As shown in FIG. 5, a non-flat surface 502 coated with a layer of photo-resist 503. As the photoresist layer is of uneven thickness, the surface morphology of the substrate with the photoresist layer is measured by a surface scanner in order to calculate the exposure dose 501 at different portions of the substrate. The exposure dose can be adjusted either by the excitation flux or the exposure time.

Once a photoresist masked with desired patterns is prepared, the sample substrate is then ready for the next process step in which the sample substrate is etched to remove the photoresist and a very thin layer of material from the surface of the substrate so as to form the marking in accordance with the present invention.

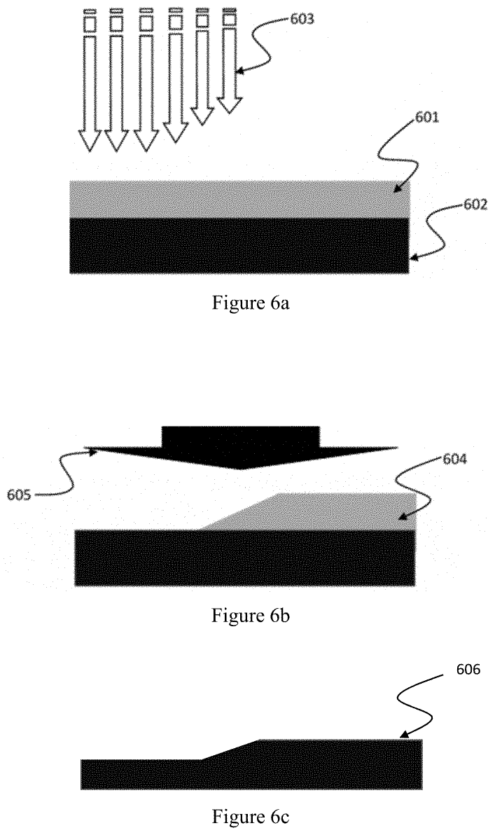

Referring to FIGS. 6a, 6b and 6c, an illustrative example is shown of the complete process of providing a marking to a solid state material according to the present invention is shown.

Firstly, as shown in FIG. 6a, a thin layer of photoresist 601 is coated on the outer surface of the substrate of a solid-state material 602. The photoresist 601 is exposed with the desired pattern by controlling the exposure dose 603 at designated area by way of grey scale lithography. In this example, the photoresist is a positive photoresist so after exposure, the exposed photoresist becomes more soluble and is readily being washed away by solvent.

Referring to FIG. 6b, the remaining photoresist pattern 604 is left on the surface of the substrate as shown.

The next process step is whereby plasma etching is applied to the surface of the substrate of the solid-state material 602. The unexposed photoresist 604 acts a protective layer on the surface of the designated region of the solid-state material 602. Since plasma etching can be a non-selective process, the material at the surface of the solid-state material 602 will be remove at a constant rate regardless of position. Therefore, the photoresist layer 601 will be removed first before the material of the solid-state material 602 underneath it. By controlling the exposure dose 605, desired 2.5D pattern can be formed on the surface 606 of the substrate of the solid-state material 602 as shown in FIG. 6c.

In reactive ion etching (RIE) processes, a typical plasma etching technique, large numbers of ions are produced that are accelerated towards the target to remove material by sputtering and related processes. Such a process is known to have low selectivity.

In comparison to RIE, inductively-coupled plasma (ICP) etching is a chemical process in which a plasma is used to breakdown the etching gases into a mixture of free radicals and ions. As such, whilst other etching processes may be implemented within the present invention, ICP etching is chemical etching process which has a higher selectivity, and is a preferred etching technique in preferred embodiments of the invention.

The present invention provides for the marking of a solid state material, in particular marking of a gemstone including diamonds.

To increase the security in maintaining the identification of gemstones including diamonds, the technical challenge to fabricate and inscribe the marking has to be increased.

The present invention provides for a new process to create a non-optically visible identifiable mark. The marking pattern created with this method is in multi-level which significantly increases the difficulty of counterfeit, allows more flexibility and uniqueness in pattern design, as well as enhances the amount of information to be inscribed by such a mark.

The marking can be made sufficiently small so as to be invisible to the naked eye, and so as not to alter the optical properties of the article to which it is applied, such as a gemstone, in particular a diamond.

In some embodiments of the invention, a marking may be applied which may be viewable and inspected by use of a 10× loupe or a 20× loupe.

In some embodiment of the invention, a marking may be applied which may be non-optically detectable under the visible light spectrum.

Particular advantages of the present invention include:
provides a marking of multiple levels, and eliminates the need for multiple masks,
allows for a highly complex marking to be provided,
allows for variants to be introduced into the marking, such that in some embodiments a marking is unique,
there is no limit on shape accuracy, and
high spatial resolution for producing exact surface profiles

Such advantages provide enhanced security, and provides significant technical impediments for the reproduction of the marking and as such, provides enhanced anti-counterfeiting attributes.

The marking method and marking from such method of the present invention provides the following further advantages:
(i) a marking which is not unsightly and which may not be readily viewed;
   (ii) a marking which, when applied to articles such as precious stones or gemstones, allows for the identification for security purposes as well as tracking and origin of the articles;
   (iii) security purposes, which may be utilized to mitigate or identify counterfeiting, and impropriety including theft and the like;
   (iv) marking of a solid-state material, without the disadvantages associated with other destructive and invasive methods of marking such as ablation, milling, engraving and the like;
   (v) a methodology and product thereof which does not alter the optical qualities or properties of a solid-state material, and which is not detrimental the clarity or colour of the solid-state material;
   (vi) a methodology and product thereof, which does not introduce contaminants or impurities to the solid-state material;
   (vii) a methodology and product thereof that requires no significant removal of material from the surface of the solid-state material; and
   (viii) a methodology and product thereof, having no associated chemical residue.

It should be noted that although the marking is of a general three-dimensional structure, the term “2.5D” or “two and a half dimensions” is used, as will be known by those skilled in the art to pertain to a structure which although can have varying heights, does not include “undercuts”. As such, the term “multi-level” is considered synonymous with 2.5D. It should also be noted that “multi-level” also includes inclined surfaces, and that the surfaces of the marking of the present invention need not be parallel with each other, and may be curved in one or more planes.

It should be noted and understood that the embodiments of the present invention illustrate the idea and principle, not limitation. In these embodiments the methodology and the implementation mechanism may be modified or substituted for an efficient presentation without departing from the scope of the invention. Thus, the appended claims are not to be limited by the embodiments.

The term “marking” is used throughout the description and claims, and such a “marking” will be understood by those skilled in the art to pertain to a “mark” provided to the surface of an article, and the terms are synonymous with each other and may be used interchangeably without alteration of meaning or interpretation.

1. A method of forming a non-optically detectable identifiable marking invisible to the naked eye, said marking is formed from a plurality of recesses of multiple levels at an outer surface of an article formed from a solid-state material, and said method including the steps of:
(i) forming a plurality of recesses of multiple levels within a predetermined region of a photoresist applied to an outer surface of an article formed from a solid-state material, wherein said plurality of recesses of multiple levels is formed by grayscale lithography and wherein said one or more recesses extend at least partially through the photoresist and towards said outer surface of the article formed from a solid-state material; and
(ii) applying an etching process such that at least a portion of the outer surface of said article is exposed and etched so as to form a plurality of etched portions extending into said article from the outer surface of the article and corresponding to said plurality of recesses;
wherein said predetermined region of said photoresist defines an identifiable marking to be applied to the outer surface of said article; wherein said plurality of etched portions forms the non-optically identifiable marking on the outer surface of said article.

2. A method according to claim 1, wherein the marking is viewable by use of a 10× loupe or a 20× loupe.

3. A method according to claim 1, the maximum width of the etched portions of the article less than 200 nm such that the identifiable marking is non-optically detectable in the visible light spectrum.

4. A method according to claim 1, wherein said plurality of recesses extend through the photoresist and so as to provide one or more apertures therethrough and providing one or more exposed portions of said outer surface of the article prior to application of the etching process, such that etched portions corresponding to the one or more apertures have depths into the article of approximately the same depth.

5. A method according to claim 1, wherein the recesses extend through the photoresist at varying depths to each other prior to application of the etching process, such that the etched portions have varying depths into the article.

6. A method according to claim 1, wherein the grayscale lithography process uses masks with holes of different sizes and shapes.

7. A method according to claim 1, wherein the grayscale lithography pattern is generated by laser interference lithography.

8. The method according to claim 1, wherein the grayscale lithography pattern is generated by direct laser writing in the photoresist.

9. A method according to claim 1, wherein the recesses of said plurality of recesses are arranged in a periodic and uniform arrangement or in a non-periodic and non-uniform arrangement with respect to each other within said predetermined region of a photoresist.

10. (canceled)

11. A method according to claim 1, wherein said photoresist has a uniform thickness or a non-uniform thickness.

12. (canceled)

13. A method according to claim 1, wherein the outer surface of said article is a flat surface or a non-flat surface.

14. (canceled)

15. A method according to claim 1, wherein the recesses of said plurality of recesses are the same width or have non-uniform widths.

16. (canceled)

17. A method according to claim 1, wherein one or more recesses is formed from a plurality of adjacent recesses.

18. A method according to claim 1, wherein the etching process is a plasma etching process.

19. A method according to claim 1, wherein one or more recesses of the plurality of recesses is inclined with respect to the outer surface of an article.

20. A method according to claim 1, wherein one or more recesses of the plurality of recesses is curved in at least one plane with respect to the outer surface of an article.

21. A method according to claim 1, wherein said solid state material is selected from the group of gemstones including diamond, pearl, silicon, and synthetic sapphire.

22. An article formed from solid state material having a non-optically detectable identifiable thereon which is invisible to the naked eye, wherein said non-optically detectable identifiable marking is applied to said solid state material by the method according to claim 1.

23. An article according to claim 22, wherein said solid state material is selected from the group of gemstones including diamond, pearl, silicon, and synthetic sapphire.

24. An article according to claim 22, wherein the marking is viewable by use of a 10× loupe or a 20× loupe.

25. An article according to claim 22, a marking may be applied which may be non-optically detectable under the visible light spectrum.
